(19) United States
(12) Patent Application Publication
(10) Pub. No.: US 2015/0321331 A1
(43) Pub. Date: Nov. 12, 2015

(54) Tool Protector

(71) Applicant: Jose Carrera, Las Cruces, NM (US)

(72) Inventor: Jose Carrera, Las Cruces, NM (US)

(21) Appl. No.: 14/709,398

(22) Filed: May 11, 2015

Related U.S. Application Data
(60) Provisional application No. 61/991,364, filed on May 9, 2014.

(51) Int. Cl. B25G 1/08; B25G 1/04

(52) U.S. Cl. CPC B25G 1/08; B25G 1/04

(57) ABSTRACT

A tool protector system for a tool projecting from a distal end of a handle is provided having a cover with a sidewall which surrounds the tool projecting from the handle when in a projecting position. The cover is translatable to a retracted position on the handle exposing the tool and distal end of the handle when the tool is to be employed. A twisting of the cover relative to the handle allows for removably engaging the cover to the handle to hold the cover either in the projecting position or retracted position. The system works especially well with tools employed for manipulating electric contacts engaged with wiring to protect the user from the business end of the tool and the tool from damage when not in use.

This application claims priority to U.S. Provisional Patent Application Ser. No. 61/991,364 filed on May 9, 2014 and which is incorporated herein in its entirety by this reference thereto.

### BACKGROUND OF THE INVENTION

1. Field of the Invention

The present invention relates to hand tools used to manipulate electrical contacts during their insertion or removal into or from rear release electrical connectors. More particularly, the disclosed device relates to a device and method providing protective covering to protect both the tool engaged to the handle and the user from the tool itself.

2. Prior Art

Machinists, craftsman, and other professionals employ a wide range of customized, expensive, and somewhat easily damaged tools. Such tools are portable and typically comprise an elongated handle having an engaged or engageable specific tool projecting from a body defining the handle at one end of the handle. Typically the tool itself is customized to the job to be performed and users of such may carry one or a plurality of such tools for use on a typical job.

In either case, the tool when not being employed, and projecting from the distal end of the body defining the handle, is easily damaged by impacts, being drop, or being otherwise mishandled. Further, many such tools can be sharp or injurious to the user should they inadvertently come into contact with the business end of the tool itself. As such, in many instances conventional guards have been developed to protect the tools in this stored state such as in a tool belt, as well as to protect the user from contact with the tool.

However, conventional such guards and protectors for these customized tools for use with wire and electrical connectors generally employ a pair of elongated members to protect the tool and to attempt to project the user from injury from the tool. However, such conventional sliding members by nature are rendered flexible in order to operate between two positions. In one position the members are retracted on the body defining the handle with the flexible projections engaging the handle and exposing the tool from the distal end of the handle A second configuration positions the flexible members extending in a direction and distance away from the distal end of the handle in positions on opposing sides of the tool projecting therefrom.

In order to operate, the prior art devices must employ these flexible members, so that the members themselves are formed of materials such as plastic, which may be bent or otherwise deformed in order to disengage from the body of the handle. Such disengagement is done when the protector is being placed in a projecting position to protect the tool and user, or translated to a retracted position where the tool is exposed for use. An example of such a conventional protective tool device is sold as tool number 539968-1 as manufactured by TE Connectivity which is located in Berwyn, Pa., in the United States.

In the projecting position which is supposed to protect the handle-engaged tool from damage, and the user from harm, in conventional guards only two sides of the tool are protected from the mishaps of mishandling, or from contact with the user. This is because conventionally since gaps exist between the two projecting flexible members. This leaves long gaps between the projecting flexible members which expose the tool to contact and damage, and expose the user to potential harms from the tool which frequently is very sharp or pointed or both.

Further, the projecting members being flexible, should a large amount of force be encountered from a side direction, they easily bend. This deflection or bending can allow an impact to contact or bend the tool they are intended to protect. Further, the bending of the members can allow the sharp or pointed tool to project from the gaps between the members and harm the user. Considering the user may carry multiple such tools at a time in a belt, or pocket, or on their person, the potential for damage to the tool, and injury to the person multiples with each such tool carried and stored.

In addition, employment of the protector in conventional tool protections is cumbersome at best. To position the conventional protector with flexible members to the retracted position to expose the tool, the user must figure out how to bend, or otherwise deform the flexible members to disengage them from a second engagement adjacent the distal end of the body forming the handle. Thereafter they slide the two members to a first engagement on a proximal end of the handle to retract the projecting members. Trying to bend or otherwise deflect the engagement end of the flexible members, while working, to move them into a stored position or retracted position, is at best an irritant to the user.

As such, there is a continuing unmet need, for system for handle-engaged tools, which provides a tool guard or protector for the tools engaged with the handle and projecting from one side thereof. Such a device should not require the user to deform or otherwise flex components to engage and disengage them to use or store the tool. Such a device should provide 360 degrees of surrounding protection when deployed and extending from the handle to protect the tool, and, to protect the user from injury from the projecting sharp or pointed tool. Such a device should be substantially rigid when deployed to an extended position, to protect the tool from impacts which frequently occur moving the tool from pocket or belt storage. Finally, such a device should be easily engaged with and disengaged with the handle, to render it easily retractable to a position to allow the tool to project from the handle, and easily returned to a projecting position protecting both the tool and the user.

The forgoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### SUMMARY OF THE INVENTION

The device herein disclosed and described provides a solution to the shortcomings in prior art. The device achieves the above noted goals through the provision of an easily engaged, and disengaged annular or cylindrical guard member. When disengaged from two connection points on the handle, the guard member is slidable between a first or projecting position surrounding the projecting tool at the distal end of the handle, to a second or retracted position, exposing the projecting tool. In the projecting position, the tool guard, provides 360 degrees of protection to protect the sharp or pointed tool projecting from on end of a handle from damage. Additionally, the cylindrical guard member also protects the user from harm from the business end of the sharp or pointed tool when carrying such on their person. The handle and cover may be formed of polymeric material, carbon fiber, plastic, metal, or other materials suitable to the task. In the case of the cover is should be formed sufficiently strong to resist impacts when in the projected position to prevent bending and breaking.

The cylindrical guard member features a cylinder which is adapted at a first end, for an easy twist engagement and disengagement at engagement points on at least one and preferably two positions of the handle. Projections extending toward the axis of an axial passage of the sliding protective cylinder at a first end, are configured for complimentary encasement into slots depending into one or a plurality of positions on the handle.

Planar areas of the handle provide a mating surface for translating the disengaged projections forward and rearward on the handle. The projection or projections once translated toward the proximal or distal end of the handle may then be rotated into an engaged position into the complimentary configured slots in the handle.

A first one or pair of projections at the opposite end of the handle from the tool, provides a retracted engagement for the projections to hold the cylinder retracted. A second one or pair of slots adjacent the tool end or distal end of the handle, allow the cylinder to be twisted and locked in position projecting from the tool end of the handle. In this projecting position, the cylindrical member protects both the tool with a rigid, 360 degree wall of protection, and the user from any contact with the sharp or pointed tool projecting from the distal end of the handle.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

It is an object of this invention to provide a tool protector and tool mount, configured to provide a telescoping cylinder of rigid material which will lock into a position projecting from the handle to protect the tool.

It is a further object of the invention to provide such a cylindrical protecting member which protects the user from the tool, and protects the tool from impacts and breaking.

It is yet another object of the invention to provide this translatable cover which is easy to engage and disengage by twisting mating connectors on the cylinder in operative engagement with mating connectors on the handle.

Additional objects, features, and advantages of the invention will be brought out in the following part of the specification, wherein detailed description is for the purpose of fully disclosing the invention without placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features. It is intended that the embodiments and figures disclosed herein are to be considered illustrative rather than limiting. In the drawings:

FIG. 1 depicts the device with the protective cylinder in a retracted positioning upon the body of the handle.

FIG. 2 depicts the device of FIG. 1 wherein the protective cylinder is translated to a projecting position surrounding the tool projecting from the handle.

FIG. 3 shows a side view of the protective cylinder of FIGS. 1-2.

FIG. 4 shows the protective cylinder of FIG. 3 with the sidewall defining the cylinder rendered transparent to allow viewing of two pair of twist engaging connectors shown in the interior cavity as complimentary shaped projections positioned at a first end configured for a complimentary engagement with the recesses formed in the body of the handle.

FIG. 5 shows the handle engaged with a tool projecting from a distal end of the body of defining the handle and having recesses formed adjacent a first end and at the opposite distal end.

FIG. 6 is an end view through the passage communicating substantially axially from the distal end of the handle and through the axial cavity of the surrounding protective cylinder having a diameter and a secondary diameter defined by the projections therein.

FIG. 7 depicts the device of FIGS. 1-2 but having a protective cylinder having an aperture formed in the sidewall allowing viewing of the protected tool.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

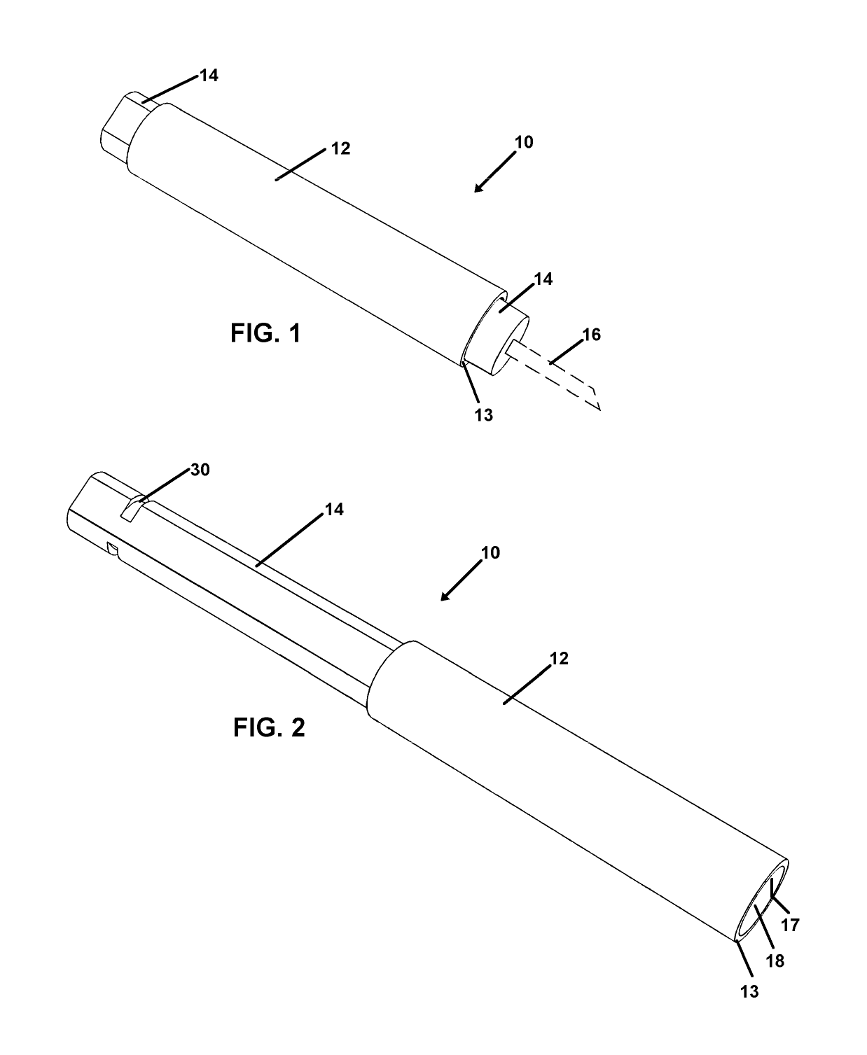

Now referring to drawings in FIGS. 1-7 there is seen in FIG. 1 the device 10 herein with a translatable cover 12 formed by a cylindrical wall 13 having an interior wall surface 17 defining a diameter of an axial cavity 18 sized in diameter to translate on the exterior surface of the body defining a handle 14. The handle has a first end opposite a distal end which is engaged with a tool 16 projecting substantially axially therefrom, which herein is depicted as a generic mode of the tool 16 since the shape and configuration of such tools is virtually limitless as they are all adapted to the task intended. By substantially axially is meant that the tool 16 or a tool engaging component, projects at, or proximate to, an axis running through the handle 12 from the first end to the distal end from which the tool 16 or tool engaging component will project.

In FIG. 1 the cover 12 is shown in a retracted position upon the handle 14 while in FIG. 2 the device 10 is shown with the cover 12 translated to the projecting position wherein it surrounds the projecting tool 16 which projects from the distal end of the handle 14 as in FIG. 1. The cover 12 can physical maintain the positioning at the retracted position using a first disengageable connection between the cover 12 and the handle 14. The cover 12 will maintain the positioning in the projecting position once translated thereto, through the engagement of a second disengageable connection between the cover 12 and the handle 14. Currently, both the first and second disengageable connections are twistable for engagement using the provided twisting complimentary connection components noted herein for engaging the cover 12 to the handle 14.

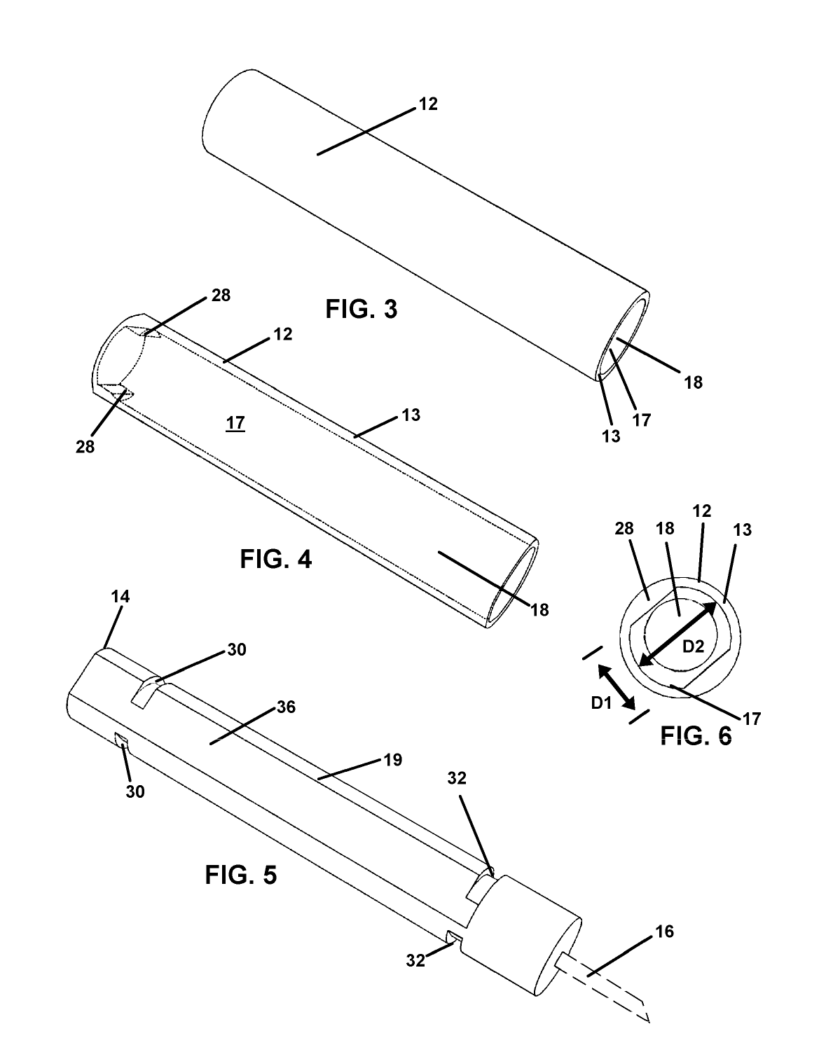

As shown in FIGS. 3-4 the protective cover 12 is formed by a cylindrical member having a sidewall 13 having an interior surface 17 defining an axial cavity 18 sized for a translatable engagement upon the exterior surface 19 of the handle 14 defining a circumferential shape and size of the handle 14. The axial cavity 18 communicates through the cover 12 from a first end having the first connector which is engageable with a mating connector shown as a first recess 30, to achieve a first rotating connection or first disengageable connection proximate thereto upon the interior surface 17 which provides for a first disengageable connection adjacent the first end of the handle 14, when engaged with a first recess 30 in the handle 14 as in FIG. 2.

In FIG. 5 is shown the handle 14 having an exterior surface 19 defining both a shape and circumferential size of the circumference of the handle 14. Proximate to a first end of the handle 14, is positioned the complimentary first mating half connector defined by first recess 30 which will form the first disengageable connection with the cover 12, at a first position adjacent the first end of the handle 14, when rotationally engaged with the projection 28. Positioned proximate to a second end or distal end of the handle 14 which is adapted for engagement with or engaged to a tool 16, is a complimentary second mating half connector defined by second recess 32, which will form the second disengageable connection at a second position on the handle 14, when engaged with the first half connector shown as the projection 28 positioned adjacent the first end of the cover 12.

To position the cover in the retracted position of FIG. 1, the user will translate the cover 12 on the handle 14 toward the first end of the handle 14 and then twist the cover 12 or handle 14 or both to engage the first half connector shown as projection 28 with the first mating half connector shown as first recess 30, to form a first disengageable connection in a first position on the handle. To position and hold the cover 12 to the projecting position of FIG. 2, the user simply twists the cover 12 in an opposite direction if necessary to disconnect the disengageable connection, and translates the cover 12 to the projecting position of FIG. 2. Thereafter twisting the cover 12 or the handle 14 or both to engage the first half connector shown as projection 28 with the second mating half connector shown as second recess 32, will form the second disengageable connection at the second position, adjacent the distal end of the handle 14, and thereby removably fix the cover 12 in that projected position until released.

The first disengageable connection and second disengageable connection can employ any complimentary half components of each which will allow the handle 14 and/or cover 12 to be rotated and to engage both in such disengageable connections. Currently as depicted, the first half connector is one or a plurality of projections 28 which are complimentary in size and shape to that of a first recess 30 or plurality thereof and to the second recess 32 or plurality thereof, such that the first and second disengageable connections may be made by rotating the handle 14 and cover 12 relative to each other such that the projection 28 will engage the first recess 30 or second recess 32. As noted other configurations of complimentary components on both the handle 14 and cover 12 may be employed to achieve the required disengageable connections to hold the cover 12 either retracted or projecting and all such connections as would occur to those skilled in the art are anticipated within the scope of this patent.

Planar portions 36 of the exterior surface 19 of the handle 14 provide gap between the interior surface of the sidewall 13 and the exterior surface of the handle 14. This gap provides a a passage for the projection 28 or projections 28 to translate along the handle 14 between the first end thereof and the distal end adjacent the tool 16.

A view through the axial cavity 18 of the cover 12 can be seen in FIG. 6. Also shown in FIG. 6 the projections 28 extending to a planar distal end and defining a first diameter D1 across the axial cavity 18 and the interior wall surface 17 of the sidewall 13 which defines a second diameter D2 across the axial cavity 18 running normal to the first diameter.

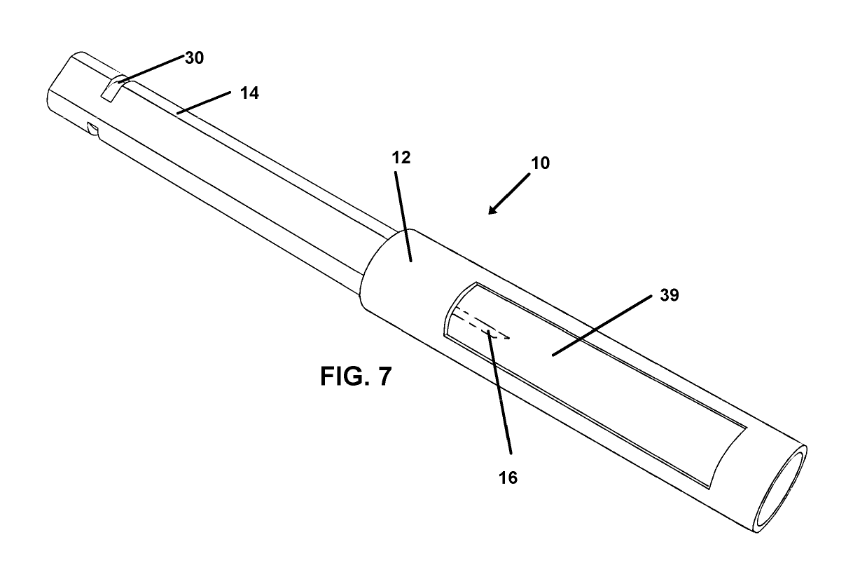

Finally, FIG. 7 depicts the device 10 of FIGS. 1-2 but having a cylinder forming the protective cover 12 which includes an open area or transparent sidewall area defining a viewing aperture 39 formed in the sidewall 13 of the cover 12. This aperture 39 defines a viewing area for the user to see the tool 16 with the cover 12 of the device 10 in the projecting position as in FIG. 2.

This invention has other applications, potentially, and one skilled in the art could discover these. The explication of the features of this invention does not limit the claims of this application; other applications developed by those skilled in the art will be included in this invention.

It is additionally noted and anticipated that although the device 10 is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A tool protector for a tool projecting from a distal end of a handle, comprising:
a handle having a first end and a distal end opposite said first end;
said distal end adapted for engagement of a tool projecting substantially axially therefrom;
said handle having a circumferential surface defining a shape of an exterior surface of said handle;
a cover having a sidewall extending between a first end of said cover and a second end thereof, said sidewall having an interior surface defining an axial cavity said first end of said cover and said second end of said cover;
said axial cavity dimensioned for a translating engagement upon said exterior surface of said handle;
said cover positionable to a retracted position with said first end of said cover in between said first end of said handle and said second end of said handle in a first disengageable connection between the cover and the handle at a first position adjacent to said first end of said handle;
said cover positionable to a projecting position with said first end of said cover in between said first end of said handle and said second end of said handle in a second disengageable connection between the cover and the handle at a second position adjacent to said second end of said handle;
said cover in said projecting position surrounding said tool;
said cover in said refracted position exposing said distal end of said handle; and
whereby said cover is user positionable to said projecting position by a user when stored to protect said tool from contact with said user or objects, and positionable to said retracted position during use of said tool.

2. The tool protector of claim 1 wherein:
said first disengageable connection between the cover and the handle comprises a projection extending from said interior surface of said axial cavity a distance into said axial cavity; and
a first recess depending into said exterior surface of said handle proximal to said first position.

3. The tool protector of claim 1 wherein:
said second disengageable connection between the cover and the handle comprises a projection extending from said interior surface of said axial cavity a distance into said axial cavity; and
a second recess depending into said exterior surface of said handle proximal to said second position.

4. The tool protector of claim 2 wherein:
said second disengageable connection between the cover and the handle comprises said projection extending from said interior surface of said axial cavity said distance into said axial cavity; and
a second recess depending into said exterior surface of said handle proximal to said second position.

5. The tool protector of claim 2 additionally comprising:
a planar portion formed into said exterior surface of said handle, said planar portion forming a gap between said interior surface of said axial cavity and said exterior surface of said handle, said gap providing a passage for translation of said projection between said first position and said second position during a translation of said cover upon said body between said retracted position and said projecting position.

6. The tool protector of claim 3 additionally comprising:
a planar portion formed into said exterior surface of said handle, said planar portion forming a gap between said interior surface of said axial cavity and said exterior surface of said handle, said gap providing a passage for translation of said projection between said first position and said second position during a translation of said cover upon said body between said retracted position and said projecting position.

7. The tool protector of claim 4 additionally comprising:
a planar portion formed into said exterior surface of said handle, said planar portion forming a gap between said interior surface of said axial cavity and said exterior surface of said handle, said gap providing a passage for translation of said projection between said first position and said second position during a translation of said cover upon said body between said retracted position and said projecting position.

8. The tool protector of claim 2 wherein:
said first disengageable connection between the cover and the handle comprises a plurality of said projections extending from said interior surface of said axial cavity a distance into said axial cavity; and
a plurality of said first recesses depending into said exterior surface of said handle proximal to said first position in positions to engage with each of said plurality of projections when said cover is rotated relative to said handle.

9. The tool protector of claim 3 wherein:
said second disengageable connection between the cover and the handle comprises a plurality of said projections extending from said interior surface of said axial cavity a distance into said axial cavity; and
a plurality of said second recesses depending into said exterior surface of said handle proximal to said second position in positions to engage with each of said plurality of projections when said cover is rotated relative to said handle.

10. The tool protector of claim 8 additionally comprising:
said second disengageable connection between the cover and the handle comprises a plurality of said projections extending from said interior surface of said axial cavity a distance into said axial cavity; and
a plurality of said second recesses depending into said exterior surface of said handle proximal to said second position in positions to engage with each of said plurality of projections when said cover is rotated relative to said handle.
